(19) United States
(12) Patent Application Publication
(10) Pub. No.: US 2026/0264278 A1
(43) Pub. Date: Sep. 10, 2026

(54) FOLDING KNIFE

(71) Applicant: HANGZHOU GREAT STAR INDUSTRIAL CO., LTD., Hangzhou City (CN)

(72) Inventor: Yueming LI, Hangzhou City (CN)

(21) Appl. No.: 19/542,403

(22) Filed: Feb. 17, 2026

Related U.S. Application Data
(63) Continuation-in-part of application No. PCT/CN2026/078487, filed on Feb. 11, 2026.

(30) Foreign Application Priority Data
Feb. 9, 2026 (CN) 202610186783.X

(51) Int. Cl. B26B 1/04; B26B 1/10

(52) U.S. Cl. CPC B26B 1/042; B26B 1/10

(57) ABSTRACT

A folding knife, comprising: a handle; a blade assembly pivotably connected to one end of the handle, the blade assembly being configured to be rotatable relative to the handle; a locking mechanism configured to be engageable with the blade assembly, wherein the folding knife is configured such that: the blade assembly has at least two states, the blade assembly is switched between different states by rotating, the locking mechanism, when engaged with the blade assembly, locks the blade assembly in a current state, and the locking mechanism, when disengaged from the blade assembly, is able to unlock the blade assembly.

### RELATED APPLICATION

This application is a continuation-in-part (CIP) application claiming benefit of PCT/CN2026/078487 filed on Feb. 11, 2026, which claims priority to Chinese Patent Application No. 202610186783.X filed on Feb. 9, 2026, the disclosures of which are incorporated herein in their entirety by reference.

### FIELD OF THE INVENTION

The present invention relates to a hand tool, and particularly to a folding knife.

### DESCRIPTION OF THE PRIOR ART

In existing folding knives, a blade portion is pivotably connected to a handle. When stowed, the blade is folded into the handle; when in use, the blade is rotated out of the handle. To ensure safety in use of the blade, some folding knives employ a locking member that applies a force to the blade, so as to retain the blade in an unfolded state or a stowed state. However, in these folding knives provided with the locking member, when the blade is subjected to an accidental impact, there still exists a possibility of unlocking, which may easily cause injury to a user. Moreover, due to the addition of the locking mechanism, unlocking is required during a process of the blade assembly transitioning from the unfolded state to the stowed state or vice versa. However, during unlocking, various components of the folding knife are prone to interference with each other, resulting in unsmooth unlocking and affecting normal use of the knife.

### SUMMARY OF THE INVENTION

To solve the above problems, the present invention aims to provide a folding knife in which, when subjected to an accidental impact, the blade does not unlock, thereby ensuring user safety, and during use, the blade unlocks smoothly without being interfered with by other components.

The folding knife provided in the present invention includes:
a handle;
a blade assembly pivotably connected to one end of the handle, the blade assembly being configured to be rotatable relative to the handle;
a locking mechanism configured to be engageable with the blade assembly;
where the folding knife is configured such that: the blade assembly has at least two states, the blade assembly is switched between different states by rotating, the locking mechanism, when engaged with the blade assembly, locks the blade assembly in a current state, and the locking mechanism, when disengaged from the blade assembly, is able to unlock the blade assembly.

Further, the blade assembly has at least a folded state and an unfolded state; in the folded state, at least a portion of the blade assembly overlaps with the handle; in the unfolded state, the blade assembly extends outward from the handle.

Further, the handle is provided with a receiving position capable of receiving the blade assembly, where:
the handle includes a first shell and a second shell, and a cavity between the first shell and the second shell serves as the receiving position; or
the handle includes a first shell and a second shell, the receiving position is provided on the first shell, and a portion of the second shell opposite to the receiving position is configured as an opening; or
the handle is formed by a single shell, and the receiving position is provided on the single shell.

Further, the locking mechanism includes a locking rod, and the locking rod is disposed on a side surface of the handle along a width direction and is pivotably connected to the handle.

Further, an end portion of the locking rod extends toward the handle to form an extension section, a rear end of the blade assembly is provided with at least a first recess and a second recess, where when the extension section engages with the first recess, the blade assembly is locked in the unfolded state; and when the extension section engages with the second recess, the blade assembly is locked in the folded state.

Further, when the extension section engages with the first recess, a first engagement surface of the extension section facing the space contacts the first recess to form a first contact surface; where a perpendicular line is drawn from an axis center of a pivot shaft of the locking rod to the engagement surface, and a foot of the perpendicular line is located within a height range of the first contact surface.

Further, a second engagement surface of the extension section away from the space engages with an engagement surface of the first recess away from the space.

Further, a clearance is provided between the engagement surface of the extension section and the engagement surface of the first recess, where a difference obtained by subtracting an interference dimension between the first engagement surface and the first recess from the clearance is not less than a preset value.

Further, a portion of the second engagement surface near a bottom of the first recess is provided with a chamfer, the chamfer has an inclined surface, and a distance between the inclined surface and the engagement surface of the first recess is greater than the clearance.

Further, the handle is provided with a stop pin, and when the extension section engages with the first recess, the stop pin contacts an engagement surface of the first recess away from the space to restrict rotation of the blade assembly.

Further, the extension section disengages from the first recess when rotating in a direction away from the first recess, where when the extension section rotates to a maximum stroke, a predetermined distance is provided between a lowermost end of the extension section near the first recess and an uppermost end of the first recess near the extension section.

Further, the locking rod is partitioned, with a pivot shaft thereof as a boundary, into a first section and a second section, the locking mechanism further includes a first resilient element, and the first resilient element applies a biasing force to the locking rod; the extension section is provided at an end portion of the first section, and pressing the second section drives the locking rod to rotate.

Further, a distance from an end portion of the first section away from the pivot shaft to the pivot shaft is not less than a distance from a farthest pressable end of the second section to the pivot shaft.

Further, when the extension section engages with the second recess, a torque generated by the extension section contacting the second recess causes the blade assembly to have a self-locking force in the second state.

Further, the second recess is provided with an arc portion.

Further, the folding knife is provided with a blocking portion, and the blocking portion is configured to restrict the blade assembly from further moving when the blade assembly rotates toward the space to a predetermined stroke.

Further, the blade assembly has a pivot hole, a pivot shaft passes through the pivot hole to pivotably connect the blade assembly to the handle; where a washer is provided or a boss is formed at an opening of the pivot hole.

Further, the locking rod has a pivot hole, a pivot shaft passes through the pivot hole to pivotably connect the locking rod to the handle, where an axis center of the pivot shaft does not coincide with a hole center of the pivot hole, such that an outer side of the locking rod is not higher than the handle.

Further, the locking mechanism includes a lock pin and a second resilient element, and one end of the lock pin passes through a hole on the first shell and is movably connected to the second shell. The second resilient element applies a biasing force to the lock pin to urge the lock pin to return. Any structure capable of providing a biasing force may serve as the second resilient element. Preferably, the second resilient element is a spring disposed between the lock pin and the handle. Preferably, a portion of the handle extends outward to form a first resilient piece, and the first resilient piece serves as the second resilient element. Preferably, a clip is connected to one side of the handle, a portion of the clip extends to form a second resilient piece, and the second resilient piece serves as the second resilient element.

Further, a rear end of the blade assembly is provided with at least a first engagement groove and a second engagement groove, and the lock pin is configured to be engageable with the first engagement groove or the second engagement groove, thereby locking the blade assembly in a current position.

Further, the lock pin is a stepped shaft and includes a first engagement portion, a second engagement portion, and a pressing end, where the pressing end protrudes outside the handle, and the first engagement portion is cylindrical and movably connected to the second shell; the second engagement portion is tapered and configured to be engageable with the first engagement groove or the second engagement groove.

Further, the second shell is provided with a hole, at least a portion of the first engagement portion falls into the hole, and an engagement part between the first engagement portion and the hole has a predetermined height.

Further, an angle range formed by a tapered edge of the second engagement portion is 20-60°.

Further, a side of the second engagement portion near the pressing end extends axially to form a cylindrical section.

Further, the first engagement groove is arc-shaped, and when the first engagement groove engages with the second engagement portion, an arc center of the first engagement groove does not coincide with an axis center of the second engagement portion, and the second engagement portion applies a preload onto the first engagement groove.

Further, the second engagement groove is arcuate, and an arc length of the second engagement groove is greater than a semi-arc, thereby forming a constricted opening at an opening of the second engagement groove.

Further, a rear end of the blade assembly is further provided with a third engagement groove, and the third engagement groove is located between the first engagement groove and the second engagement groove.

The present invention has the following beneficial effects:
1. The locking rod forms a hook portion via its extension section to engage with the recess of the blade assembly. By setting a range for the perpendicular line position from the center of the pivot shaft of the locking rod to the engagement surface between the inner side of the hook portion and the recess of the blade assembly, reliable engagement between the locking rod and the blade assembly is achieved, thereby improving locking safety of the folding knife in the unfolded state, and preventing unlocking even when subjected to accidental impact. Providing a chamfer on the hook portion of the locking rod avoids interference during unlocking. By setting a distance after the hook portion disengages from the recess to satisfy a certain range, failure to unlock caused by insufficient movement of the locking rod is avoided, thereby ensuring smooth unlocking. In the folded state, a certain constraint is imposed on the distance between the hook portion and the pivot shaft of the blade assembly, such that a self-locking force acting on the blade assembly is not less than a preset value, thereby improving safety of the tool in the folded state. Providing a blocking portion prevents excessive movement and damage of the blade assembly. Reasonably setting a segment ratio of the locking rod ensures that an unlocking force is neither excessive nor compromises self-locking safety. Offsetting the center of the pivot shaft of the locking rod relative to the pivot hole eliminates protrusion and exposure of the locking rod.
2. Locking is achieved by using a lock pin. An engagement height between the lock pin and the handle is set, and a distance after the lock pin disengages from the engagement groove of the blade assembly is set. Reinforcement is provided at a connection position between the lock pin and the handle. An engagement portion of the lock pin with the engagement groove is configured as a tapered surface. The lock pin is designed with segmented portions, thereby effectively improving locking safety of the folding knife and achieving smoother unlocking.

### BRIEF DESCRIPTION OF THE DRAWINGS

FIG. 1 is an axonometric view of a folding knife according to Embodiment 1.

FIG. 2 is a schematic exploded view of a folding knife according to Embodiment 1.

FIG. 3 is a partial exploded view of a folding knife according to Embodiment 1, showing a bottom of a handle.

FIG. 4 is a partial exploded view of a folding knife according to Embodiment 1, showing a top of a handle.

FIG. 5 is a front view of a folding knife according to Embodiment 1.

FIG. 6 is a cross-sectional view taken along I-I in FIG. 5, showing a washer.

FIG. 7 shows a boss of a pivot hole of a blade module.

FIG. 8 is a top view of a folding knife according to Embodiment 1.

FIG. 9 is a cross-sectional view taken along II-II in FIG. 8.

FIG. 10 is a schematic view showing a first resilient element which is a torsion spring.

FIG. 11 is a schematic view showing a first resilient element which is a spring.

FIG. 12 is a schematic internal structural view of a handle of a folding knife according to Embodiment 1.

FIG. 13 is a schematic exploded view of a blade module and a locking rod.

FIG. 14 shows a positional relationship between a locking rod and a blade module when engaged.

FIG. 15 shows a structure in which a stop pin is used to restrict a blade module from rotating.

FIG. 16 shows a chamfer structure of a second engagement surface of an extension section.

FIG. 17 shows a positional relationship when an extension section disengages from a first recess of a blade module.

FIG. 18 is a partial enlarged view of FIG. 17;

FIG. 19 shows a positional relationship between a locking rod and a handle.

FIG. 20 shows lengths of a first section and a second section of a locking rod.

FIG. 21 shows a force relationship when a locking rod locks a blade module in a folded position.

FIG. 22 shows three implementations of a blocking portion.

FIG. 23 shows a dimension by which an axis center of a pivot shaft of a locking rod deviates from a pivot hole.

FIG. 24 shows a force diagram of a blade assembly in an unfolded state without a first resilient element.

FIG. 25 shows a force diagram of a blade assembly in a folded state without a first resilient element.

FIG. 26 shows a blade assembly which is a single blade component.

FIG. 27 shows a second shell having a notch.

FIG. 28 shows a handle formed by only one shell.

FIG. 29 is an axonometric view of a folding knife according to Embodiment 2.

FIG. 30 is an exploded view of a folding knife according to Embodiment 2.

FIG. 31 is an axonometric view of a folding knife according to Embodiment 2 from another perspective.

FIG. 32 is a front view of a folding knife according to Embodiment 2.

FIG. 33 is a cross-sectional view taken along III-III in FIG. 32.

FIG. 34 is a schematic enlarged view of a circular area in FIG. 33.

FIG. 35 is a partially enlarged schematic view of FIG. 34, showing a clearance between a first engagement portion and a second hole.

FIG. 36 shows a positional relationship therebetween when a lock pin disengages from a blade module.

FIG. 37 is a cross-sectional view taken along IV-IV in FIG. 32.

FIG. 38 is an internal structural view of a handle of a folding knife according to Embodiment 2.

FIG. 39 shows an exploded view of a lock pin and a handle.

FIG. 40 shows a structure of a blade module.

FIG. 41 is a top view of a folding knife according to Embodiment 2.

FIG. 42 is a cross-sectional view taken along V-V in FIG. 41.

FIG. 43 shows an axonometric view and a front view of a lock pin.

FIG. 44 shows a positional relationship when a first engagement groove engages with a lock pin.

FIG. 45 shows a structure of a folding knife according to Embodiment 2 in a folded state.

FIG. 46 shows a side view of a folding knife, where a second resilient element and a handle are integral.

FIG. 47 is a cross-sectional view taken along VI-VI in FIG. 46, showing a second resilient element which is a resilient piece on a handle.

FIG. 48 is an axonometric view of a handle, showing a second resilient element which is a resilient piece on a handle.

FIG. 49 is a schematic view showing connection of a clip to a handle, where a resilient piece formed on the clip serves as a second resilient element.

FIG. 50 is a front view of a folding knife, showing connection of a clip to a handle.

FIG. 51 is a cross-sectional view taken along VII-VII in FIG. 50, showing a schematic view of connection of a clip to a handle.

FIG. 52 is an axonometric view of a clip, showing a resilient piece on the clip.

### DETAILED DESCRIPTION OF THE PREFERRED EMBODIMENTS

In order to make the objectives, technical solutions, and advantages of the present invention clearer, the technical solutions in the embodiments of the present invention will be clearly and completely described below in conjunction with the accompanying drawings in the embodiments of the present invention. Clearly, the described embodiments are only some, rather than all, embodiments of the present invention. Based on the embodiments of the present invention, all other embodiments obtained by those skilled in the art without contributing any inventive labor still fall within the scope of protection of the present invention.

The terms “include”, “have”, and any variations thereof in the description and claims of the present invention are intended to cover non-exclusive inclusions. For example, a method or product containing a series of technical features is not necessarily limited to those clearly listed, but may also include other technical features that are not clearly listed and can be included in the method or product.

In the description of the present invention, it should be understood that the terms “front”, “back”, and the like indicate orientation or positional relationships based on the orientation or positional relationships shown in the accompanying drawings, only for the convenience of describing the present invention and simplifying the description, instead of indicating or implying that the device or element referred to must have a specific orientation, be constructed and be operated in a specific orientation, and thus cannot be understood as limitations on the present invention.

In the description of the present invention, it needs to be understood that the technical features defined by the terms such as “first” and “second” with a sequential concept are only intended to clearly describe the defined technical features, so that the defined technical features can be distinguished from other technical features, do not represent such naming in actual implementation, and thus cannot be understood as limiting the present invention.

### Embodiment 1

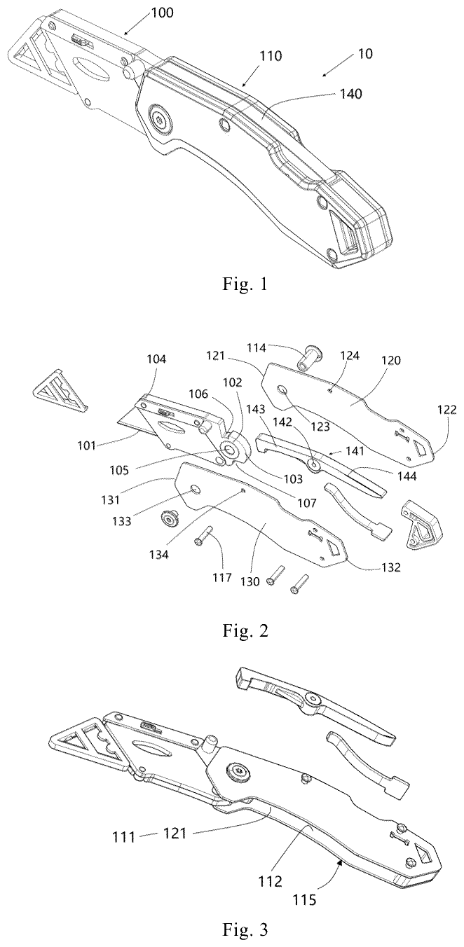

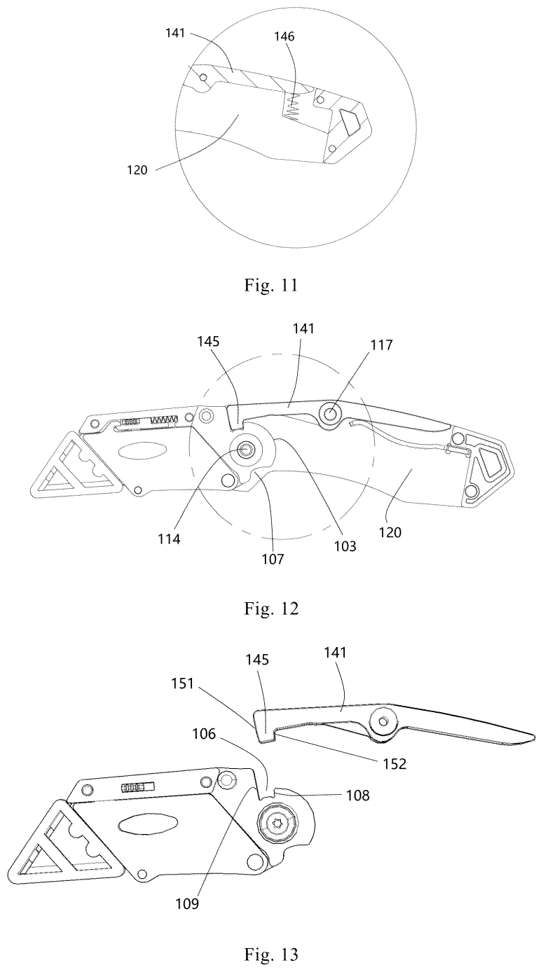

FIG. 1 to FIG. 28 show Embodiment 1. As shown in FIG. 1 and FIG. 3, this embodiment provides a folding knife 10, including a blade assembly 100 and a handle 110. The blade assembly 100 is rotatably connected to the handle 110 via a pivot shaft.

The blade assembly 100 has a working portion 101 and a connecting portion 102, where the connecting portion 102 is adjacent to a rear end 103 of the blade assembly 100, and the connecting portion 102 is pivotably connected to the handle 110. The working portion 101 is a part of the folding knife 10 for performing its function. For example, when the folding knife 10 is used to cut an object, the working portion 101 is a cutting edge of a blade; if the folding knife 10 is used for opening a bottle, the working portion 101 is a hook-shaped bottle opener. This embodiment is described with the working portion 101 being a cutting edge. In some implementations, as shown in FIG. 26, the blade assembly 100 may be composed of a single blade component, i.e., the blade assembly 100 includes only the blade component. In some implementations, as shown in FIG. 2, the blade assembly 100 at least includes a blade and a blade holder 104, where the blade is fixed to the blade holder 104, and the blade and the blade holder 104 move relative to the handle 110 as an integral unit. The blade holder 104 is pivotably connected to the handle 110. It should be understood that the specific structure of the blade assembly 100 does not constitute a limitation to the present application.

Referring to FIG. 5 and FIG. 21, the blade assembly 100 has at least two states relative to the handle 110. A first state is an unfolded state, in which the blade assembly 100 rotates relative to the handle 110, and the blade assembly 100 rotates in a direction X1 away from the handle 110 (hereinafter referred to as a forward direction) to an end of a stroke thereof, and the blade assembly 100 is in an unfolded position, at which the blade assembly 100 extends outward from the handle 110. A second state is a folded state, in which the blade assembly 100 rotates relative to the handle 110 in a direction X2 toward the handle 110 (hereinafter referred to as a reverse direction) to an end of a stroke thereof, and the blade assembly 100 is in a folded position, at which at least a portion of the working portion 101 of the blade assembly 100 overlaps with the handle 110. It should be understood that the blade assembly 100 may further have a third state relative to the handle 110, i.e., a position of the blade assembly 100 relative to the handle 110 is a position between the unfolded position and the folded position, and the blade assembly 100 may be locked at this position to be retained at this position.

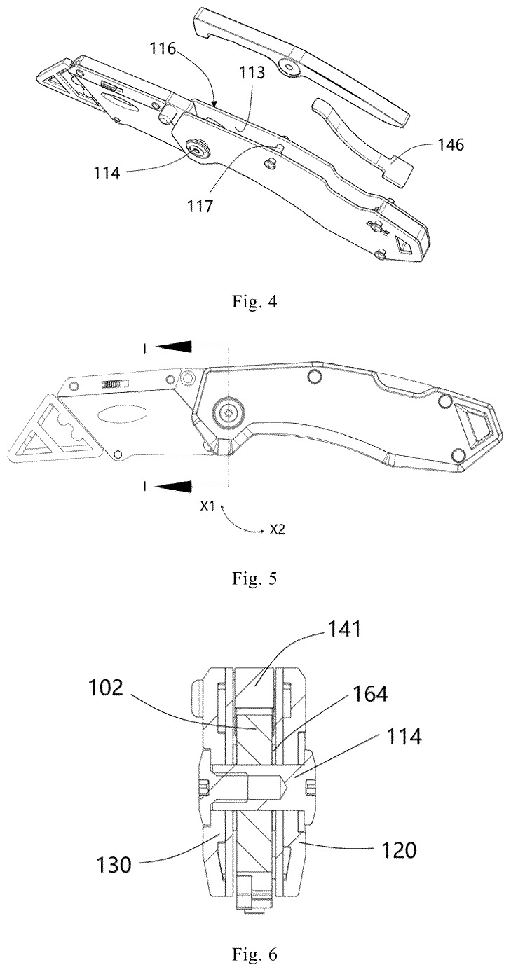

The folding knife 10 further includes a locking mechanism 140, and the locking mechanism 140 can lock the blade assembly 100 in the unfolded position, the folded position, or other intermediate positions. Referring to FIG. 4, the locking mechanism 140 is movably connected to the handle 110 and is connected to the blade assembly 100, so as to apply a locking force to the blade assembly 100.

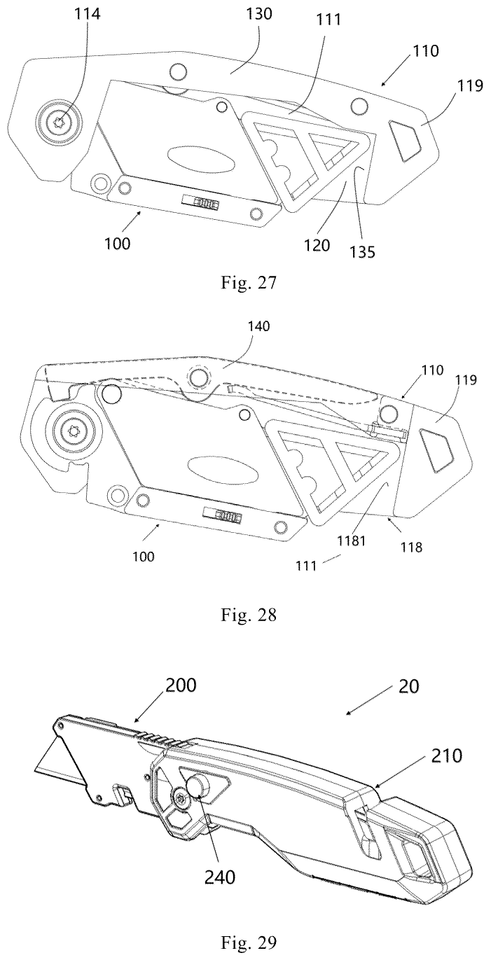

When the blade assembly 100 is in the folded state, at least a portion of the working portion 101 of the blade assembly 100 overlaps with the handle 110, i.e., the blade assembly 100 and the handle 110 are superimposed in a thickness direction of the handle 110. In some implementations, referring to FIG. 3, a receiving position 111 capable of receiving the blade assembly 100 is formed in the handle 110, and at least a portion of the folded blade assembly 100 is located at the receiving position 111, thereby overlapping with the handle 110. In some implementations, the handle 110 may include a first shell 120 and a second shell 130, the first shell 120 and the second shell 130 are disposed opposite to each other and connected by fasteners, and a cavity 121 is formed between the two to serve as the receiving position 111. The cavity 121 has a first opening 112 for the blade assembly 100 to pass through so as to enter the cavity 121 or be rotated out of the cavity 12, and at least a portion of the blade assembly may be located in the cavity 121. It should be understood that a single shell may also be used to form the cavity 121 and the first opening 112. Specifically, after the single shell is molded, the interior of the single shell is hollowed out to form the cavity 121, and the first opening is provided on a side surface of the single shell. In some implementations, as shown in FIG. 27, when the blade assembly 100 is in the folded state, a portion of the second shell 130 facing a side surface of the blade assembly 100 forms an opening 135, and the shape of the opening 135 substantially matches the blade assembly 100, such that the receiving position 111 is the opening. In other words, the second shell 130 has solid portions only at locations such as the first pivot shaft 114, a rear portion 119 of the handle 110, and the locking mechanism 140, and is disposed opposite to the first shell 120, shielding the first pivot shaft 114, the rear portion, the locking mechanism 140, and the like, without shielding the blade assembly 100 in the folded position. Through this opening 118, the folded blade assembly 100 can be seen from the outside. It should be understood that the first shell 120 may alternatively be provided with an opening, while the second shell 130 is not provided with an opening. In some implementations, as shown in FIG. 28, the handle 110 is composed of only one shell, i.e., the handle 110 includes only a third shell 118, a recessed region 1181 is formed on the third shell 118, and the recessed region 1181 serves as the receiving position 111. In this structure, the third shell 118 shields only one side surface of the blade assembly 100, and the other side surface of the blade assembly 100 is exposed. At the locking mechanism 140, a shielding structure may be formed on the third shell 118 to shield the locking mechanism.

The following further describes other components and their connections by taking the structure in which the handle 110 has the first opening 112 and the cavity 121 as an example. It should be understood that the specific structure of the handle 110 does not constitute a limitation to the present application.

A first side surface 115 of the handle 110 along a width direction is formed with the first opening 112. The first shell 120 has a first end 121 and a second end 122 opposite to each other along a length direction thereof, and the second shell 130 has a first end 131 and a second end 132 opposite to each other along a length direction thereof. A first pivot hole 123 is provided on the first shell 120 adjacent to the first end 121 thereof, and a second pivot hole 133 is provided on the second shell 130 adjacent to the first end 131 thereof. A third pivot hole 105 is provided at the connecting portion 102 of the blade assembly 100. A first pivot shaft 114 sequentially passes through the first pivot hole 123, the third pivot hole 105, and the second pivot hole 133, such that the blade assembly 100 is pivotably connected to the handle 110, and the rear end 103 is located between the first shell 120 and the second shell 130.

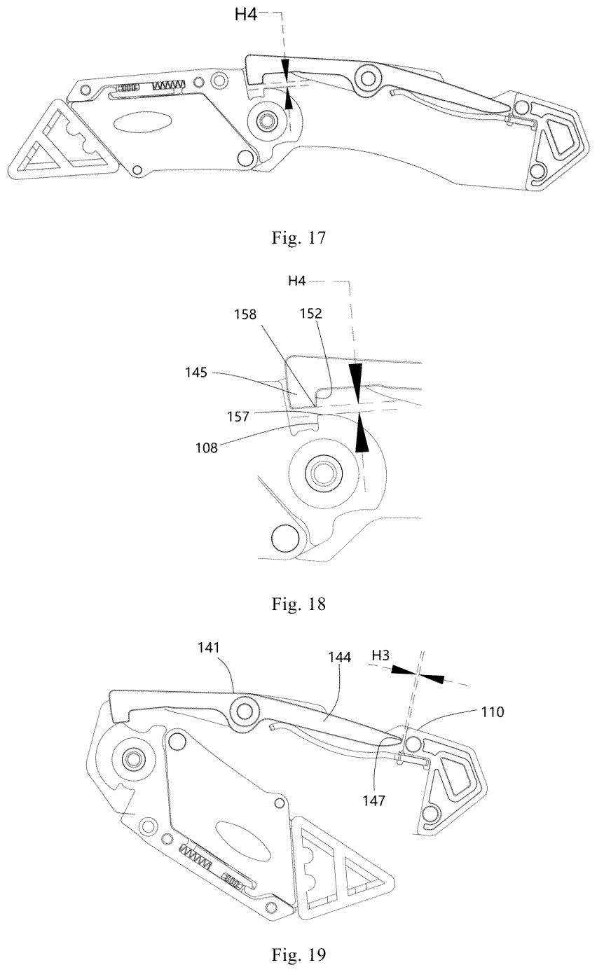

The locking mechanism 140 is detachably connected to the blade assembly 100. When the locking mechanism 140 is engaged with the blade assembly 100, the locking mechanism 140 applies a locking force to the blade assembly 100, thereby retaining the blade assembly 100 in a current position. When the locking mechanism 140 is disengaged from the blade assembly 100, the blade assembly 100 is unlocked and may rotate relative to the handle 110 under a drive by an external force or gravity. In this embodiment, as shown in FIG. 2 and FIG. 4, the locking mechanism 140 may include a locking rod 141, and the locking rod 141 is pivotably connected to the handle 110. Preferably, the handle 110 has, along a width direction thereof, a second side surface 116 opposite to the first side surface 115, the second side surface 116 is provided with a second opening 113 extending along a length direction of the handle 110, the shape of the second opening 113 matches the locking rod 141, and the locking rod 141 is disposed at the second opening 113. It should be understood that whether to provide the second opening depends on the structure of the handle 110. If the handle 110 has a space for the locking rod 141 to rotate, the second opening may be omitted. A fourth pivot hole 142 is provided at a middle portion of the locking rod 141, a fifth pivot hole 124 is provided on the first shell 120, and a sixth pivot hole 134 is provided on the second shell 130. A second pivot shaft sequentially passes through the sixth pivot hole 134, the fourth pivot hole 142, and the fifth pivot hole 124, thereby pivotably connecting the locking rod 141 to the handle 110. Defined by the fourth pivot hole 142, the locking rod 141 is partitioned into a first section 143 and a second section 144. A free end of the first section 143 is provided with an engagement portion detachably connected to the blade assembly 100. In use, pressing the second section 144 drives the locking rod 141 to rotate relative to the handle 110, such that the free end of the first section 143 rotates away from the handle 110, and the engagement portion disengages from the blade assembly 100. In some implementations, the free end of the first section 143 is provided with an extension section 145 formed by extending toward the blade assembly 100, and the extension section 145 serves as the engagement portion. The blade assembly 100 is provided with a first recess 106 and a second recess 107 matching the extension section 145. Referring to FIG. 9 and FIG. 12, when the blade assembly 100 is in the unfolded position, the extension section 145 falls into the first recess 106 and can lock the blade assembly 100, so as to retain the blade assembly 100 in the unfolded state. Referring to FIG. 17, when the extension section 145 disengages from the first recess 106, the blade assembly 100 is unlocked, allowing the blade assembly 100 to rotate. When the blade assembly 100 is in the folded position, the extension section 145 falls into the second recess 107 and can lock the blade assembly 100, so as to retain the blade assembly 100 in the folded state. In some implementations, as shown in FIG. 9 to FIG. 11, the locking mechanism 140 further includes a first resilient element 146. The first resilient element 146 is respectively connected to the locking rod 141 and the handle 110, thereby applying a biasing force to the locking rod 141. The biasing force can urge the free end of the first section 143 to rotate toward the handle 110. The first resilient element 146 may be a resilient piece, a compression spring, an extension spring, a torsion spring, or any other element capable of providing a biasing force. The specific structure of the first resilient element 146 does not constitute a limitation to the present application.

The locking rod 141 can be used to lock the blade assembly 100 in a specific position. Pressing the second section 144 of the locking rod 141 can achieve unlocking. However, in some usage scenarios, when the blade assembly 100 is subjected to an accidental impact, there still exists a possibility of unlocking, which may cause injury to a user. Moreover, after the blade assembly 100 is unlocked, interference between components may result in unsmooth unlocking, affecting convenience of use. To further improve the safety of the folding knife 10 and ensure reliable locking of the blade assembly 100 as well as smoother unlocking and stowing, this embodiment further optimizes the engagement design between the locking mechanism 140 and the blade assembly 100, as specifically described below.

### I. Engagement Design of Blade Assembly 100 and Locking Rod 141 in Unfolded State

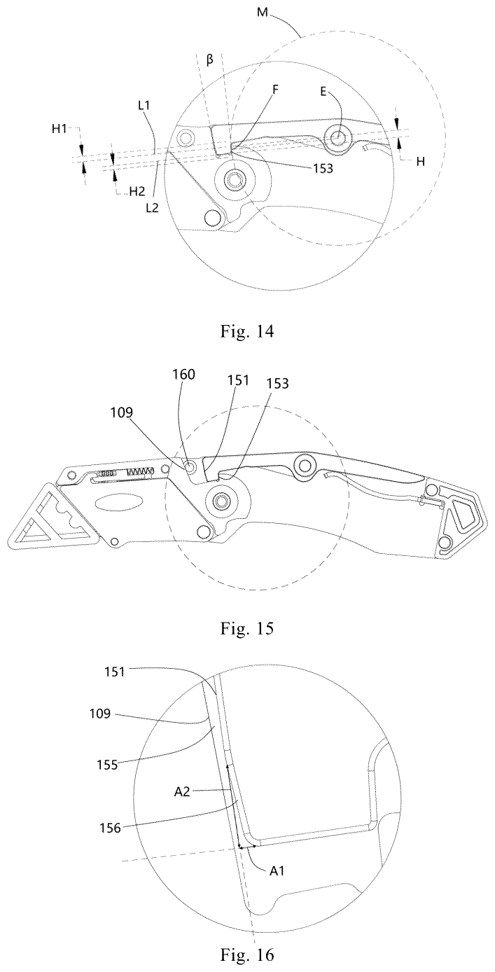

FIG. 12, FIG. 13, and FIG. 14 show structural views of the blade assembly 100 in the unfolded position. The extension section 145 of the locking rod 141 has a first engagement surface 151 and a second engagement surface 152 opposite to each other along a length direction of the locking rod 141, where the first engagement surface 151 is located on an outer side of the extension section 145 (i.e., a side away from the fourth pivot hole 142), and the second engagement surface 152 is located on an inner side of the extension section 145. The first recess 106 of the blade assembly 100 has a third engagement surface 108 that contacts the second engagement surface 152.

As shown in FIG. 14 and FIG. 15, when the extension section 145 engages with the first recess 106, the second engagement surface 152 at least partially contacts the third engagement surface 108 to form a first contact surface 153. The first contact surface 153 is used to restrict reverse rotation of the blade assembly 100 (i.e., rotation toward the folding direction). When the blade assembly 100 is in the unfolded state and subjected to an external impact urging the blade assembly 100 toward the folding direction, under the restriction of the first contact surface 153, the blade assembly 100 will not be unlocked, thereby avoiding inadvertent injury to a user. The first contact surface 153 has a height H. The height H needs to be selected within a reasonable range, so as to ensure both that the locking rod 141 can reliably lock the blade assembly 100 and that unlocking is smooth. Preferably, H>1 mm, and more preferably, H>1.5 mm. A circle M in the figure represents a trajectory circle of the second engagement surface 152 of the locking rod 141 rotating about an axis center of the second pivot shaft. A perpendicular line is drawn from an axis center E of the pivot shaft of the locking rod 141 (i.e., the second pivot shaft) to the second engagement surface 152, and a foot of the perpendicular line is F (i.e., a tangent point of the second engagement surface 152 and the circle M). In a preferred implementation, the foot F is located within the first contact surface 153. If in some implementations the foot F exceeds a range of the first contact surface 153, the following requirements shall be met: the first contact surface 153 has an upper edge L1 and a lower edge L2; if the foot F is located above L1, a height range H1 from the upper edge L1 is set, and the foot F falls within the height range H1; preferably, H1≤1 mm; if the foot F is located below L2, a height range H2 from the lower edge L2 is set, and the foot F falls within the height range H2; preferably, H2≤1 mm. It should be understood that specific values of H, H1, and H2 are not limited to the values recited herein and may be optimally selected according to factors such as materials of respective components of the folding knife 10, dimensions of the folding knife 10, and the like.

The first recess 106 of the blade assembly 100 has a fourth engagement surface 109, and the fourth engagement surface 109 is opposite to the third engagement surface 108. In some implementations, as shown in FIG. 14, when the blade assembly 100 is in the unfolded state, the first engagement surface 151 of the extension section 145 engages with the fourth engagement surface 109 of the first recess 106 of the blade assembly 100. A second contact surface can restrict the blade assembly 100 from rotating in the forward direction X1. When a user uses the folding knife 10 to cut an object, a force applied by the object to the blade assembly 100 urges the blade assembly 100 to rotate in the forward direction X1. Under the restriction of the first engagement surface 151 and the fourth engagement surface 109, the blade assembly 100 does not rotate, facilitating convenient use. During unlocking, the second section 144 of the locking rod 141 is pressed, the first section 143 rotates away from the handle 110, and the extension section 145 needs to disengage from the first recess 106. Due to factors such as machining accuracy, the extension section 145 may interfere with the fourth engagement surface 109 of the first recess 106 during rotation. To achieve smoother unlocking and engagement, referring to FIG. 14, an included angle β may be formed between the first engagement surface 151 and the second engagement surface 152 of the extension section 145, i.e., the first recess 106 and the extension section 145 are wedge-shaped. Specifically, at an end portion of the extension section 145 away from the locking rod 141, a distance between the first engagement surface 151 and the second engagement surface 152 is minimal, thereby forming the included angle β between the first engagement surface 151 and the second engagement surface 152. In addition, a clearance 155 may or may not exist locally between the first engagement surface 151 and the fourth engagement surface 109. However, after the two are properly engaged, there must be local contact engagement therebetween to prevent rotation or wobbling of the blade.

When designing a size of the clearance 155, it is also necessary to consider possible interference between the second engagement surface 152 and the third engagement surface 108 in some design situations. For example, as shown in the figures, when the extension section 145 is rotated out of the first recess 106, a difference obtained by subtracting an interference dimension between the second engagement surface 152 and the third engagement surface 108 from the clearance between the first engagement surface 151 and the fourth engagement surface 109 cannot be less than a preset value. Herein, the interference dimension between the second engagement surface 152 and the third engagement surface 108 refers to: when locked, the second engagement surface 152 and the third engagement surface 108 are in contact; when the extension section 145 rotates relative to the first recess 106, interference occurs between the second engagement surface 152 and the third engagement surface 108, thereby resulting in an interference dimension. Generally, the interference dimension is approximately 0.02 mm. Preferably, the preset value is set to 0.2 mm, the clearance dimension is 0.24 mm, and a difference between the clearance dimension and the interference dimension is 0.22 mm, which is greater than the preset value. When the extension section 145 enters the first recess 106, a certain end portion movement space is required to facilitate smooth entry.

Further, a chamfer 156 may also be provided on the first engagement surface 151. As shown in FIG. 16, a portion of the first engagement surface 151 near a bottom thereof forms an inclined surface, and a distance between the inclined surface and the fourth engagement surface 109 of the first recess 106 is larger than a distance between other portions of the first engagement surface 151 and the fourth engagement surface 109, which can further avoid interference of the first recess 106 with the extension section 145 during rotation. Preferably, the chamfer 156 has a dimension range of (0.2-1) mm×(2-5) mm, where (0.2-1) mm is a length A1 of the chamfer 156 cut into the first engagement surface 151 relative to other portions thereof, and (2-5) mm is a length A2 of the chamfer 156. More preferably, the chamfer 156 has a dimension of 0.3 mm ×3 mm.

Referring to FIG. 17, when the blade assembly 100 is in the unfolded state, the extension section 145 is rotated such that the extension section 145 disengages from the first recess 106, thereby releasing the locking of the blade assembly 100. During this process, as shown in the figure, the free end 147 of the second section 144 of the locking rod 141 rotates toward an interior of the handle 110, and the extension section 145 rotates toward an exterior of the handle 110. The blade assembly 100 can rotate only when the second engagement surface 152 of the extension section 145 is completely out of contact with the third engagement surface 108 of the first recess 106. In an ideal state, when the locking rod 141 is rotated to a maximum stroke, an uppermost end 157 of the third engagement surface 108 of the first recess 106 closest to the locking rod 141 is exactly out of contact with a lowermost end 158 of the second engagement surface 152 closest to the blade assembly 100. At this moment, the locking of the blade assembly 100 is released, and the blade assembly 100 can begin to rotate in the folding direction. However, considering factors such as machining errors and materials, when the blade assembly 100 and the locking rod 141 are in the ideal state of just being out of contact, interference with rotation of the blade assembly 100 may occur, thereby restricting rotation of the blade assembly 100. For this reason, when the locking rod 141 is rotated to the maximum stroke, a certain distance H4 between the uppermost end 157 and the lowermost end 158 needs to be considered. Preferably, H4≥0.2 mm, and more preferably ≥0.5 mm. In addition, as shown in the figure, the extension section 145 rotates toward the outside of the handle 110, while the free end 147 of the second section 144 rotates toward the inside of the handle 110. If the free end 147 of the second section 144 is blocked by the handle 110, the extension section 145 will also be unable to rotate. Therefore, a clearance H3 needs to be provided between a side of the free end 147 of the second section 144 adjacent to the handle 110 and the handle 110. Considering that the locking rod 141 functions similarly to a lever, the length of the second section 144 may be greater than that of the first section 143, and thus a stroke of the free end 147 of the second section 144 is greater than a stroke of the extension section 145. Therefore, the clearance H3 between the free end and the handle 110 may be set to be greater than H4, and preferably, the clearance is greater than 1 mm.

In the above implementations, the first engagement surface 151 of the extension section 145 is at least in partial contact with the fourth engagement surface 109 of the first recess 106 to restrict forward rotation of the blade assembly 100. In some implementations, as shown in FIG. 15, a stop pin 160 may be provided on the handle 110. When the blade assembly 100 rotates in the forward direction (i.e., rotates in a direction opposite to the folding direction) to a maximum stroke, the extension section 145 falls into the first recess 106, the second engagement surface 152 contacts the third engagement surface 108 to lock the blade assembly 100, and at the same time, the fourth engagement surface 109 of the first recess 106 contacts the stop pin 160, and the stop pin 160 restricts forward rotation of the blade assembly 100 (i.e., rotation in the direction opposite to the folding direction).

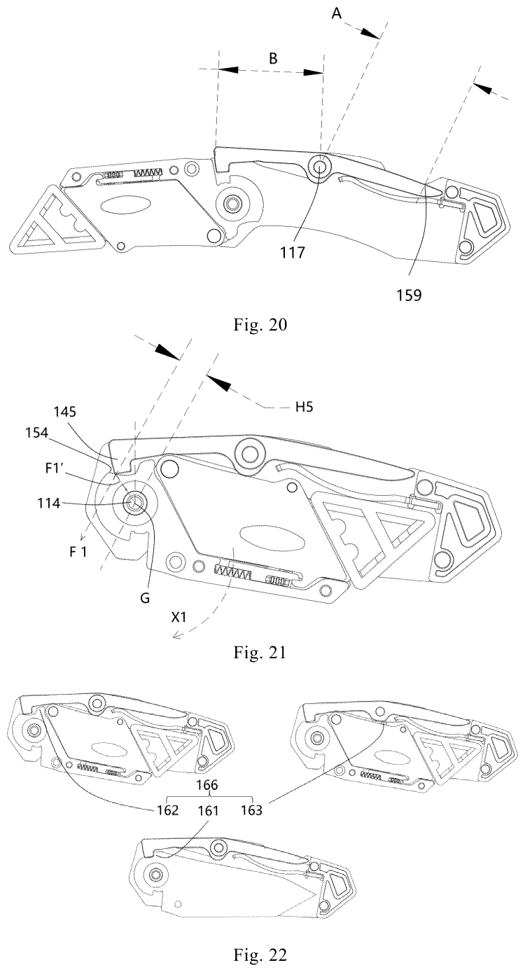

When the blade assembly 100 is in the unfolded position, pressing the second section 144 of the locking rod 141 toward the handle 110 causes the locking rod 141 to rotate, thereby unlocking the blade assembly. A locking force of the locking rod 141 is provided by the first resilient element 146. Pressing the second section 144 overcomes the biasing force of the first resilient element 146, thereby urging the locking rod 141 to rotate. If the locking force is too small, although it is easy to open, locking reliability is insufficient; if the locking force is too large, unlocking difficulty increases. Therefore, a balance needs to be struck between locking reliability and unlocking operability. As shown in FIG. 20, the locking rod 141 is partitioned, with the fourth pivot hole 142 as a boundary, into a first section 143 and a second section 144. These two sections form a lever structure with the second pivot shaft as a fulcrum. By reasonably setting lengths of the first section 143 and the second section 144, a balance between locking reliability and unlocking operability can be well achieved. Preferably, a length of the first section 143 is B (a distance from the axis center E of the second pivot shaft to an end portion of the first section 143 away from the axis center E), and a length of the second section 144 is A (a distance from the axis center E of the second pivot shaft to a farthest pressable end 159 of the second section 144). Generally, A=B or A<B may be set, and in combination with an elastic coefficient of the first resilient element 146, an unlocking pressing force of 20-50 N may be set.

In some implementations, the locking mechanism 140 may not include the first resilient element 146. As shown in FIG. 24 and FIG. 25, no resilient element is provided between the locking rod 141 and the handle 110; instead, a self-locking force is generated between the locking rod 141 and the blade assembly. FIG. 24 shows the unfolded state. The locking rod 141 falls into the first recess 106, and a first contact surface 153 is formed between the second engagement surface of the extension section 145 and the first recess 106. A perpendicular line is drawn from the axis center E of the second pivot shaft to the first contact surface 153, and a foot of the perpendicular line is F. At this moment, the first recess 106 applies a force F3 to the extension section 145. A point of application of the force F3 is within a range of the first contact surface 153 between the first recess 106 and the extension section 145, and a direction of the force F3 coincides with a direction of a line connecting the axis center E and the foot F, i.e., the direction of the force F3 is on an extension line of the line EF or parallel to the line EF. Under such circumstances, even without the first resilient element 146, when the blade assembly 100 is subjected to a sudden external impact, the blade assembly locks tightly with the extension section 145 of the locking rod 141 under the external force, and can still be effectively locked in the unfolded state without suddenly rotating toward the folding direction and causing injury to the user. Similarly, FIG. 25 shows the folded state. The locking rod 141 engages with the second recess 107, and the first engagement surface 152 of the extension section 145 engages with the first recess 106. A perpendicular line is drawn from the axis center E of the second pivot shaft to the fourth engagement surface 109 of the first recess 106, and a foot of the perpendicular line is F′. At this moment, the first recess 106 applies a force F4 to the extension section 145. A point of application of the force F4 is within a range of the fourth engagement surface 109 of the first recess 106, and a direction of the force F4 coincides with a direction of a line connecting the axis center E and the foot F′, i.e., the direction of the force F4 is on an extension line of the line EF′ or parallel to the line EF′. Under such circumstances, even without the first resilient element 146, when the blade assembly 100 is subjected to a sudden external impact, the blade assembly locks tightly with the extension section 145 of the locking rod 141 under the external force, and can still be effectively locked in the folded state without suddenly rotating toward the unfolding direction and causing injury to the user.

### II. Engagement Design of Blade Assembly 100 and Locking Rod 141 in Folded State

When the blade assembly 100 is in the folded position, at least a majority thereof overlaps with the handle 110, and preferably, at least a majority thereof is located in the receiving position 111 of the handle 110. At this time, the locking mechanism 140 locks the blade assembly 100, preventing the blade assembly 100 from being inadvertently opened.

As shown in FIG. 21, the blade assembly 100 is in the folded position, and the extension section 145 of the locking rod 141 falls into the second recess 107. At this time, the first resilient element 146 provides a locking force to the locking rod 141, which in turn acts on the second recess 107 via the extension section 145. To rotate the blade assembly 100 out of the handle 110, an external force needs to be applied to the blade assembly 100 to overcome the locking force. When the extension section 145 is in the second recess 107, an end portion of the extension section 145 abuts against a bottom of the second recess 107. At this time, a force F1 applied by the extension section 145 to the second recess 107 generates a torque on the blade assembly 100 with an axis center G of the first pivot shaft 114 as a fulcrum. A direction of the torque urges the blade assembly 100 to move toward the folding direction, thereby enabling the blade assembly 100 to have a self-locking force in the folded state. It should be noted that a direction of the force F1 may be determined by shaping a contact surface between the second recess 107 and the extension section 145. There exists a situation where, when the direction of the force F1 passes through the axis center G of the first pivot shaft 114 (i.e., a force represented by F1′ in the figure), F1′ cannot generate a torque with the axis center G as a fulcrum. Therefore, this situation needs to be avoided when shaping the contact surface between the second recess 107 and the extension section 145. In addition, it should also be noted that if the direction of the force F1 is located on a right side of F1′, a torque generated by F1 acting on the blade assembly 100 will not lock the blade assembly 100. Preferably, the direction of the force F1 is located on a left side of F1′.

As shown in FIG. 21, a torque generated by the force F1 with the axis center G as a fulcrum is determined by a magnitude of the force F1 and a distance H5 between the force F1 and the axis center G. When the blade assembly 100 is in the folded position, it is necessary to ensure that the blade assembly 100 is not easily opened, thereby improving locking reliability, while at the same time the torque should not be too large, so as to avoid difficulty in opening the blade assembly 100. Preferably, H5 is set to be not less than 4 mm.

In some implementations, to improve unlocking reliability when the blade assembly 100 is unfolded from the folded position, an arc portion 154 is provided on the second recess 107 (see FIG. 21). A position of the arc portion 154 protrudes relative to a bottom of the second recess 107, such that the blade assembly 100 is not easily disengaged and unlocked, and a certain external force is required to urge the blade assembly 100 to be opened, thereby enhancing locking reliability in the folded state.

The force F1 applied by the locking rod 141 to the blade assembly 100 urges the blade assembly 100 to move in the folded direction. If the blade assembly 100 continues to move after entering a predetermined position of the handle 110, the blade assembly 100 may over-travel, resulting in a consequence that a cutting edge of the blade assembly 100 may damage other components inside the handle 110, or the blade assembly 100 provided with a protective sheath may interfere with the handle 110, causing the blade assembly 100 to become stuck. To this end, in this embodiment, a blocking portion 166 is provided at a stroke end of the blade assembly 100 in the folded direction, so as to prevent the blade assembly 100 from further rotating. In some implementations, as shown in FIG. 22(c), the blocking portion 166 is a sidewall 161 of the second recess 107. When the extension section 145 engages with the second recess 107, the sidewall 161 abuts against the second engagement surface 152 of the extension section 145. In some implementations, as shown in FIG. 22(a), a second protrusion 162 is provided on a side of the second recess 107 of the blade assembly 100. When the blade assembly 100 moves in the folded direction to the stroke end, the second protrusion 162 contacts a sidewall of the handle 110 or the locking rod 141, thereby preventing the blade assembly 100 from further moving. In some implementations, as shown in FIG. 22(c), a third protrusion 163 is provided on the sidewall of the handle 110. When the blade assembly 100 moves in the folded direction to the stroke end, the blade assembly 100 contacts the third protrusion 163, and the third protrusion 163 prevents the blade assembly 100 from further moving. It should be understood that a structure of the blocking portion 166 is not limited to the above implementations, and other structures capable of preventing the blade assembly 100 from further moving in the folded direction may also be applied in this embodiment.

### III. Stability Design of First Pivot Shaft 114 of Folding Knife 10

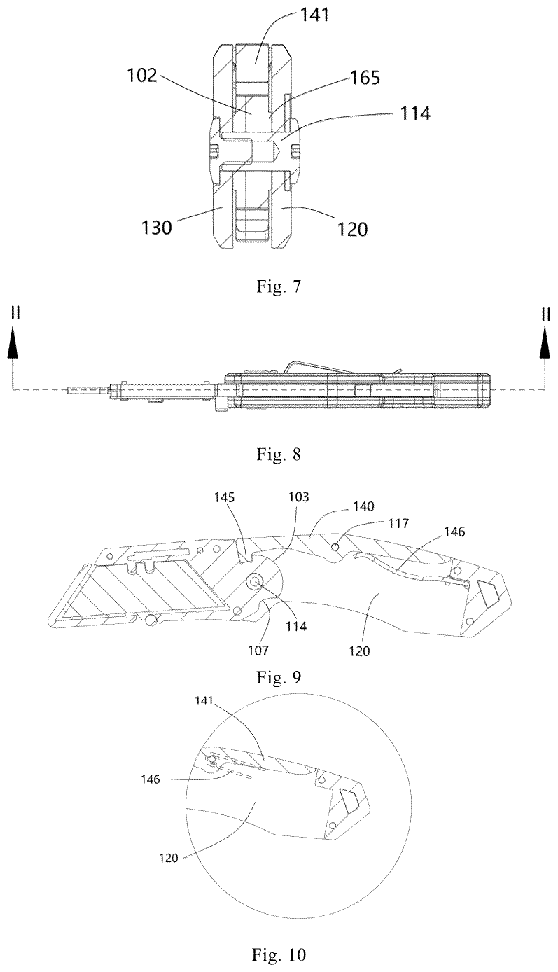

When the folding knife 10 is in use, the blade assembly 100 is required not to wobble back and forth along a thickness direction of the folding knife 10 (i.e., an axial direction of the first pivot shaft 114). To reduce wobbling of the blade assembly 100, in some implementations, as shown in FIG. 6, a washer 164 is sleeved on the first pivot shaft 114 to increase a thickness of the connecting portion 102 of the blade assembly 100, thereby reducing wobbling. In some implementations, as shown in FIG. 7, an edge of the third pivot hole 105 is configured as a boss 165, i.e., openings on both sides of the third pivot hole 105 respectively protrude outward to form the boss 165. Preferably, for the blade assembly 100 manufactured by a sheet metal working process, the washer 164 may be employed; for a blade formed by molding processes such as die casting, injection molding, powder metallurgy, and the like, the boss 165 structure may be employed.

### IV. Dimension Design of Locking Rod 141

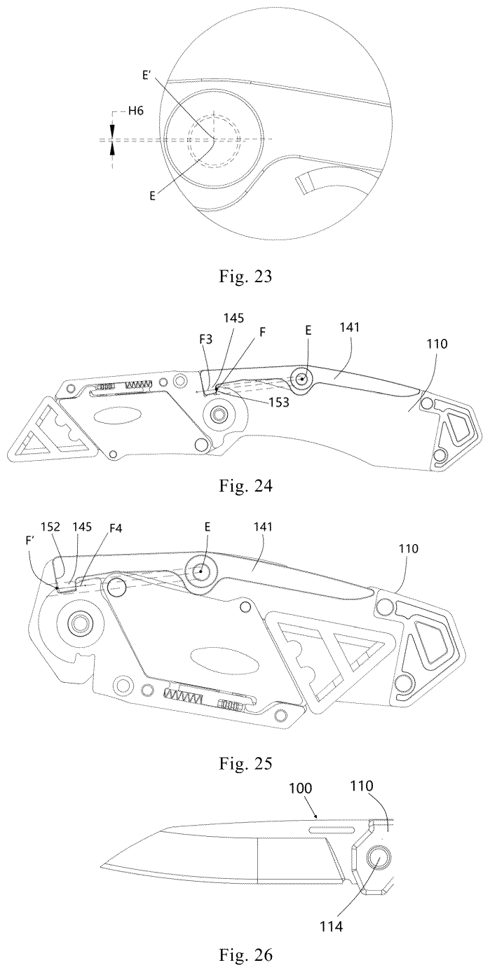

As described above, the locking rod 141 is disposed in the opening on the second side surface 116 of the handle 110. Preferably, an outer side of the locking rod 141 is not higher than the handle 110. Generally, the outer side of the locking rod 141 is made as flush with a top of a sidewall of the second opening of the handle 110 as possible, or slightly lower than the sidewall. Theoretically, the axis center E of the second pivot shaft 117 coincides with a hole center E′ of the fourth pivot hole 142. However, due to errors caused by assembly, machining, and the like, the locking rod 141 may easily protrude from the handle 110 after assembly. To eliminate an influence of the errors, as shown in FIG. 23, the second pivot shaft may be offset relative to the fourth pivot hole 142, such that the axis center E of the second pivot shaft does not coincide with the theoretical hole center E′ of the fourth pivot hole 142 (the two coincide after actual assembly). Preferably, the hole center E′ is moved downward by a height H6, and H6 may be set to 0.2 mm.

This embodiment provides a folding knife 10, which utilizes the locking rod 141 to lock the blade assembly 100. By designing an engagement portion between the locking rod 141 and the blade assembly 100, a clearance design of the locking rod 141, a lever ratio design of the locking rod 141, and the like, safety of the blade of the folding knife 10 in the unfolded state is improved, locking is reliable and smooth, unlocking does not occur when subjected to an external impact, no interference occurs during unlocking, and it is convenient to use.

### Embodiment 2

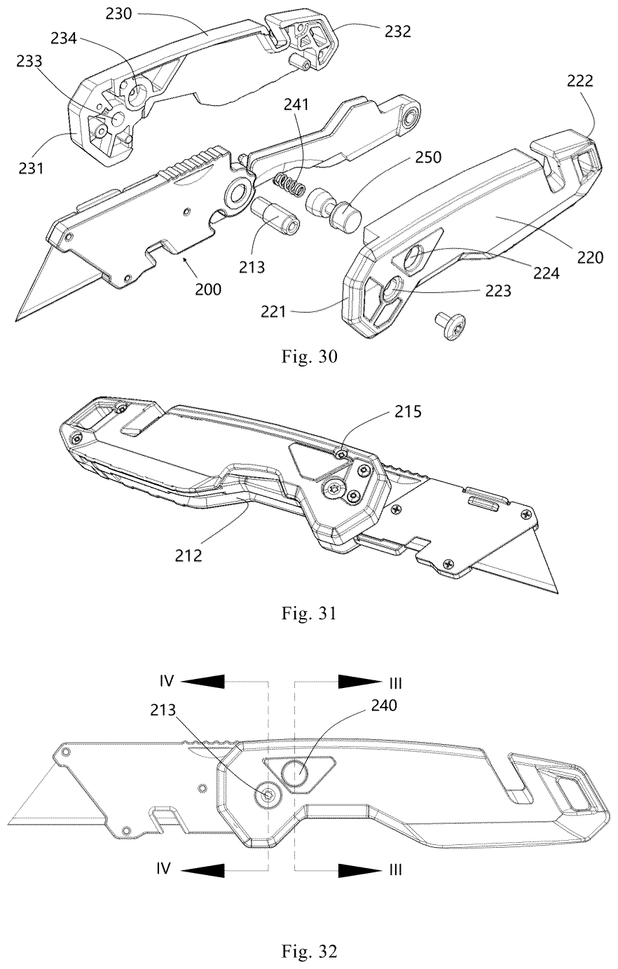

FIG. 29 to FIG. 52 show Embodiment 2. As shown in FIG. 29 and FIG. 30, this embodiment provides a folding knife 20, including a blade assembly 200 and a handle 210. The handle 210 has a space 211 therein capable of receiving the blade assembly 200 (see FIG. 38), and the blade assembly 200 is rotatably connected to the handle 210 via a pivot shaft. Referring to FIG. 32 and FIG. 45, the blade assembly 200 has at least two states relative to the handle 210. A first state is an unfolded state, in which the blade assembly 200 rotates relative to the handle 210, the blade assembly 200 is rotated out of the receiving space 211 of the handle 210 and rotates in a direction away from the handle 210 to an end of a stroke thereof, and the blade assembly 200 is in an unfolded position. A second state is a folded state, in which the blade assembly 200 rotates relative to the handle 210 in a direction toward the handle 210 to an end of a stroke thereof, and the blade assembly 200 is in a folded position. At this time, the blade assembly 200 is received in the receiving space 211 of the handle 210, and at least a portion of the blade assembly 200 is located in the receiving space 211. It should be understood that the blade assembly 200 may further have a third state relative to the handle 210, i.e., a position of the blade assembly 200 relative to the handle 210 is an intermediate position between the unfolded position and the folded position, and the blade assembly 200 may be locked at this intermediate position to be retained at this intermediate position.

The folding knife 20 further includes a locking mechanism 240, and the locking mechanism 240 can lock the blade assembly 200 in the unfolded position, the folded position, or other positions.

As shown in FIG. 40, the blade assembly 200 has a working portion 201 and a connecting portion 202, where the connecting portion 202 is adjacent to a rear end 203 of the blade assembly 200 along a length direction thereof, and the connecting portion 202 is pivotably connected to the handle 210. The working portion 201 is a part of the folding knife 20 for performing its function. For example, when the folding knife 20 is used to cut an object, the working portion 201 is a cutting edge of a blade; if the folding knife 20 is used for opening a bottle, the working portion 201 is a hook-shaped bottle opener. This embodiment is described with the working portion 201 being a cutting edge. In some implementations, the blade assembly 200 may be composed of a single blade component, i.e., the blade assembly 200 includes only the blade component. In some implementations, as shown in FIG. 40, the blade assembly 200 at least includes a blade and a blade holder 204, where the blade is fixed to the blade holder 204, and the blade and the blade holder 204 move relative to the handle 210 as an integral unit. The blade holder 204 is pivotably connected to the handle 210. It should be understood that the specific structure of the blade assembly 200 does not constitute a limitation to the present application.

A space 211 is formed in the handle 210 for receiving the folded blade assembly 200. The space 211 has a first opening 212 (see FIG. 231), through which the blade assembly 200 passes to enter the space 211 or to be rotated out of the space 211. A locking mechanism 240 is movably connected to the handle 210 and is connected to the blade assembly 200, so as to apply a locking force to the blade assembly 200. In some implementations, as shown in FIG. 30, the handle 210 may include a first shell 220 and a second shell 230. The first shell 220 and the second shell 230 are disposed opposite to each other, and the space 211 is formed between the two. As shown in FIG. 31, a first side surface of the handle 210 along a width direction thereof is formed with the first opening 212. The first shell 220 has a first end 221 and a second end 222 opposite to each other along a length direction thereof, and the second shell 230 has a first end 231 and a second end 232 opposite to each other along a length direction thereof. A first pivot hole 223 is provided on the first shell 220 adjacent to the first end 221 thereof, and a second pivot hole 233 is provided on the second shell 230 adjacent to the first end 231 thereof. A third pivot hole 205 is provided at the connecting portion 202 of the blade assembly 200. A third pivot hole 205 is provided on the blade assembly 200 adjacent to a rear end 203 thereof. A first pivot shaft 213 sequentially passes through the first pivot hole 223, the third pivot hole 205, and the second pivot hole 233, such that the blade assembly 200 is pivotably connected to the handle 210, and the rear end 203 is located between the first shell 220 and the second shell 230. It should be understood that the handle structures shown in FIG. 27, FIG. 28, and FIG. 29 of Embodiment 1 are applicable to this embodiment, and detailed description thereof is omitted herein.

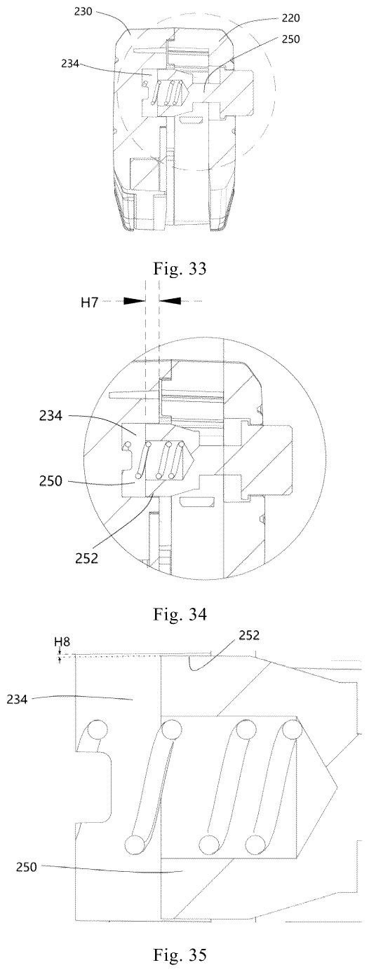

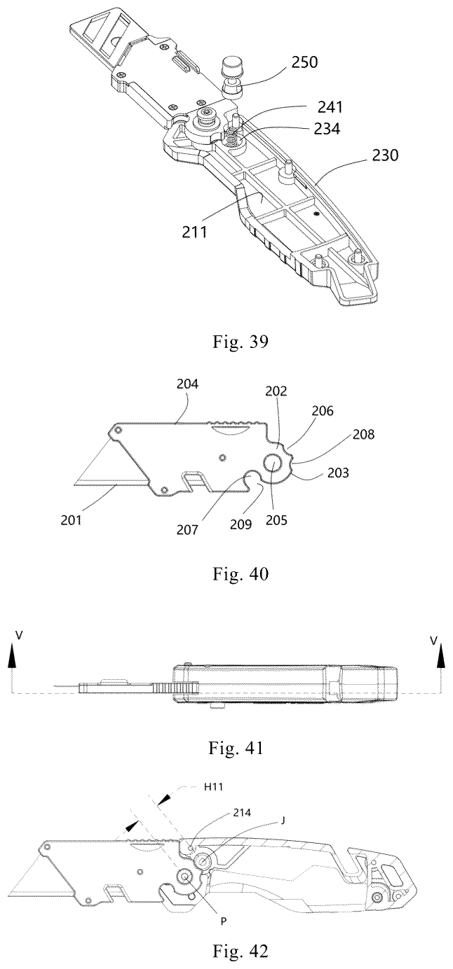

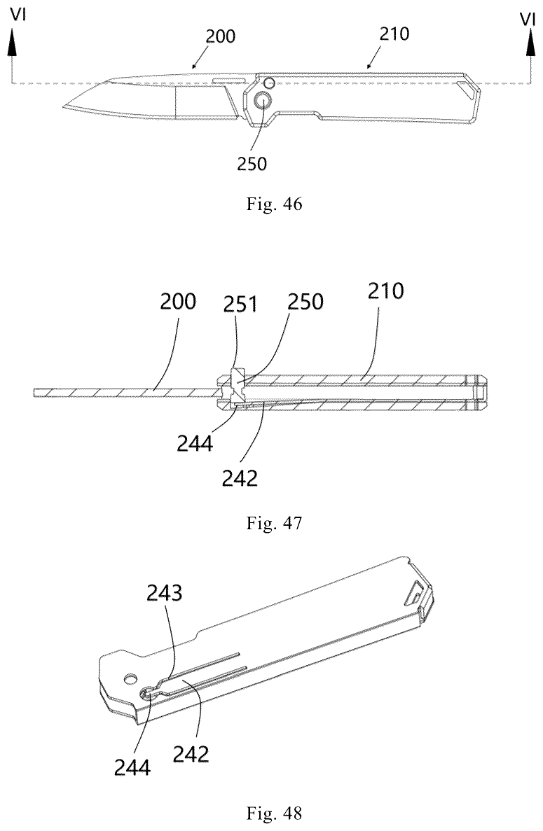

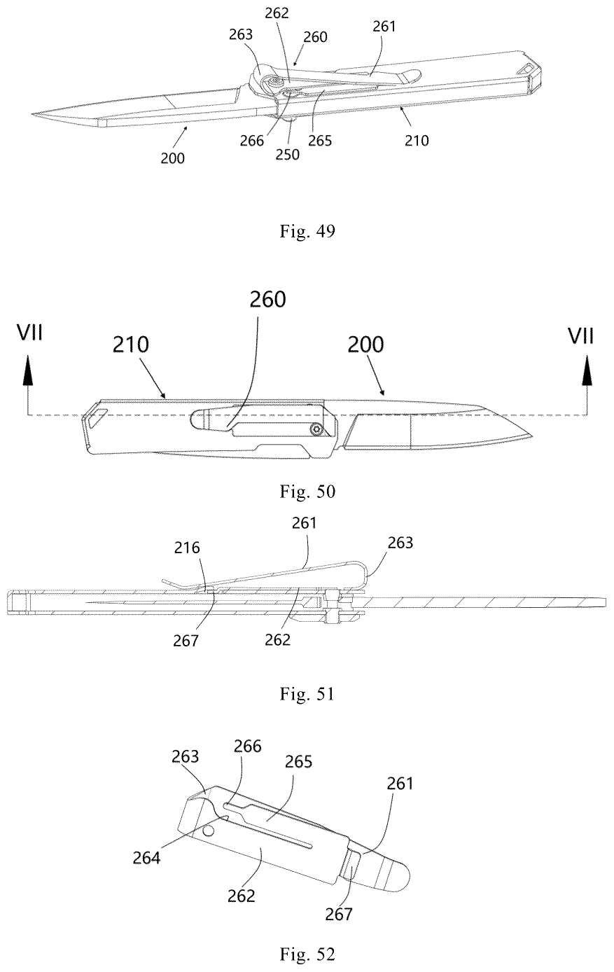

The locking mechanism 240 is detachably connected to the blade assembly 200. When the locking mechanism 240 is engaged with the blade assembly 200, the locking mechanism 240 applies a locking force to the blade assembly 200, thereby retaining the blade assembly 200 in a current position. When the locking mechanism 240 is disengaged from the blade assembly 200, the blade assembly 200 is unlocked and may rotate relative to the handle 210 under a drive by an external force. In this embodiment, referring to FIG. 30, FIG. 33, FIG. 38, and FIG. 39, the locking mechanism 240 may include a lock pin 250 and a second resilient element 241. The first shell 220 is provided with a first hole 224 for the lock pin 250 to pass through, and the second shell 230 is provided with a second hole 234 that cooperates with the lock pin 250. One end of the lock pin 250 passes through the first hole 224 and then can fall into the second hole 234, and the other end thereof protrudes outside the handle 210 as a pressing end 251 for a user to press. The second resilient element 241 applies a biasing force to the lock pin 250 to urge the lock pin 250 to return. In some implementations, as shown in FIG. 30, the second resilient element is a spring, two ends of which respectively abut against the lock pin 250 and the handle 210, thereby applying a biasing force to the lock pin 250. In some implementations, as shown in FIG. 46 to FIG. 48, the second resilient element 241 is a part of the handle 210. Specifically, an elongated groove is formed on an inner sidewall of the handle 210, and a portion of the handle 210 extends within the elongated groove 243 to form a first resilient piece 242. A free end 244 of the first resilient piece 242 is located at an end portion of the lock pin 250 (an end portion opposite to the pressing end 251) and abuts against the lock pin 250, thereby applying a biasing force to the lock pin 250. In some implementations, as shown in FIG. 49 to FIG. 52, a clip 260 is connected to a side surface of the handle 210. A portion of the clip 260 connected to the handle 210 extends to form a second resilient piece 265 as the second resilient element 241. A free end 266 of the second resilient piece 265 is located at an end portion of the lock pin 250 and abuts against the lock pin 250, thereby applying a biasing force to the lock pin 250. Preferably, the clip 260 includes a first clamping piece 261, a second clamping piece 262, and a connecting piece 263. One end of the first clamping piece 261 and one end of the second clamping piece 262 are connected via the connecting piece 263, such that the first clamping piece 261 can be closed or opened relative to the second clamping piece 262, and a biasing force is provided therebetween. The second clamping piece 262 is fixedly connected to the handle 210 by fasteners or the like. Specifically, referring to FIG. 51, an end of the second clamping piece 262 adjacent to the connecting piece 263 is connected to the handle 210 via a fastener; the handle 210 is provided with a receiving groove 216, and an end portion 267 of the second clamping piece 262 opposite to the connecting piece 263 is inserted into the receiving groove 216. After the first clamping piece 261 is opened, the folding knife 20 can be clamped onto certain objects, and then the first clamping piece 261 returns under the biasing force, thereby clamping and fixing the folding knife 20 together with the second clamping piece 262. The second clamping piece 262 is provided with a notch 264, and a portion of the second clamping piece 262 extends at the notch 264 to form a second resilient piece 265. A free end 266 of the second resilient piece 265 is located at an end portion of the lock pin 250. It should be understood that the form of the second resilient element is not limited to the spring or resilient piece as described above, and other elements capable of applying a biasing force to the lock pin are applicable to the present application.

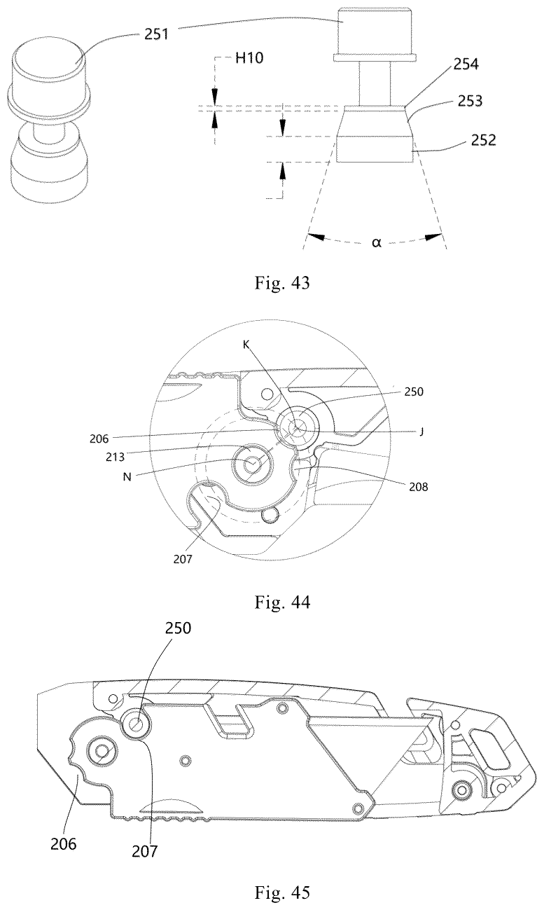

In some implementations, the lock pin 250 is columnar and is a stepped shaft. As shown in FIG. 43, the lock pin 250 at least includes a first engagement portion 252 and a second engagement portion 253, where the first engagement portion 252 may fall into the second hole 234, and the second engagement portion 253 is detachably connected to the blade assembly 200. Preferably, the first engagement portion 252 is cylindrical. The second engagement portion 253 is tapered, and an angle between two side edges of a circumferential cross-section thereof is α. Preferably, α ranges from 20° to 60°, and more preferably from 30° to 45°. H12 is a height of the first engagement portion 252, which may be determined according to actual requirements. In some implementations, a side of the second engagement portion 253 near the pressing end further extends axially to form a cylindrical section 254. The cylindrical section 254 has an axial height H10, and H10 may be set to 0-1 mm, preferably 0.5 mm.

Referring to FIG. 40, a rear end 203 of the blade assembly 200 is arcuate. A circumference of the rear end 203 is provided with at least two arcuate engagement grooves that cooperate with the second engagement portion 253, namely, a first engagement groove 206 and a second engagement groove 207. Referring to FIG. 42, when the first engagement groove 206 engages with the second engagement portion 253, the blade assembly 200 is in a fully unfolded state and located at a fully unfolded position. Referring to FIG. 45, when the second engagement groove 207 engages with the second engagement portion 253, the blade assembly 200 is in a folded state and located at a folded position. Preferably, a third engagement groove 208 is further provided between the first engagement groove 206 and the second engagement groove 207. When the third engagement groove 208 engages with the second engagement portion 253, the blade assembly 200 is in an intermediate position.

When the lock pin 250 engages with any one of the engagement grooves on the blade assembly 200, it is in a locked state, that is, the blade assembly 200 is locked in a current position. At this time, at least a portion of the first engagement portion 252 of the lock pin 250 falls into the second hole 234. The second engagement portion 253 engages with the engagement groove on the blade assembly 200, that is, at least a portion of the second engagement portion 253 is located in the engagement groove. Since the second engagement portion 253 is tapered, it can adapt to engagement grooves of various sizes, making locking more reliable. Pressing the pressing end 251 of the lock pin 250 overcomes the biasing force of the second resilient element 241, the second engagement portion 253 disengages from the engagement groove, unlocking the blade assembly 200, and the blade assembly 200 can rotate to switch positions.

To ensure locking reliability and prevent unlocking of the blade assembly 200 when subjected to an accidental impact, this embodiment further optimizes the engagement design among the lock pin 250, the handle 210, and the blade assembly 200, as specifically described below.

When the lock pin 250 engages with any one of the engagement grooves on the blade assembly 200, it is in a locked state. At this time, as shown in FIG. 34, a height H7 of an engagement portion between the first engagement portion 252 and the second hole 234 of the handle 210 is set within a reasonable range, which can enhance strength of the engagement between the lock pin 250 and the handle 210, making the lock pin 250 less likely to disengage from the handle 210, thereby improving locking reliability. Preferably, H7 is 0.2-5 mm. More preferably, H7 is 0.5-1.5 mm.

Since the lock pin 250 is pressed or returned by the second resilient element 241, the first engagement portion 252 slides along an axial direction of the second hole 234. To ensure smooth unlocking, as shown in FIG. 35, a clearance H8 is provided between the first engagement portion 252 and a circumferential sidewall of the second hole 234. Preferably, H8≥0.1 mm and ≤0.5 mm. H8 may be selected with different values according to materials. For example, when a steel sheet is used, it may be 0.1 mm; when an aluminum alloy is used, a minimum clearance between the second hole 234 and the first engagement portion 252 is 0.1 mm.

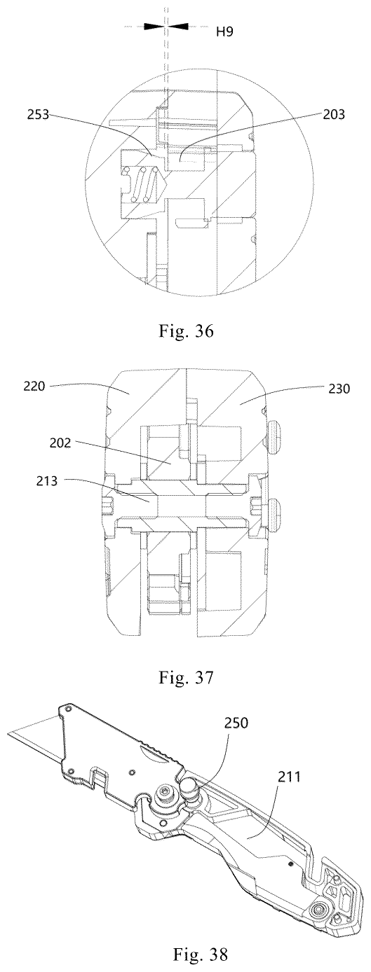

During unlocking, the lock pin 250 is pressed. In an ideal state, unlocking is successful when an end of the second engagement portion 253 closest to the blade assembly 200 disengages from the engagement groove of the blade assembly 200. However, due to factors such as manufacturing accuracy, the above ideal state may still cause interference, that is, the second engagement portion 253 may hinder rotation of the blade assembly 200. Therefore, a clearance between the second engagement portion 253 and the blade assembly 200 in a pressed and unlocked state needs to be reasonably designed. Referring to FIG. 36, preferably, after the end of the second engagement portion 253 closest to the blade assembly 200 disengages from the engagement groove, a distance between it and the engagement groove is H9. Preferably, H9 is 0.2-3 mm, and more preferably, H9 is 0.5-1 mm. By setting a reasonable range for H9, smooth pressing and unlocking can be ensured, avoiding interference with rotation of the blade assembly 200 caused by insufficient pressing of the lock pin 250 when H9 is too small.

Referring to FIG. 42, the lock pin 250 has an axis center J, and the first pivot shaft 213 of the blade assembly 200 has an axis center P. If a distance H11 between the axis center J and the axis center P is too small, it may result in insufficient strength of the handle 210 and the blade assembly 200 may easily wobble. Preferably, H11 is set to 7-15 mm, and more preferably 10.5-11 mm. To further enhance strength of the lock pin 250 and the handle 210, a reinforced connection portion is provided on the handle 210 at a position adjacent to the lock pin 250. Specifically, a reinforced connection hole 214 is provided on the handle 210, and then a fastener 215 is assembled in the reinforced connection hole 214.

The first engagement groove 206 of the blade assembly 200 engages with the second engagement portion 253 of the lock pin 250, and the blade assembly 200 is fully unfolded. The first engagement groove 206 is substantially arcuate in shape and matches a circumferential shape of the second engagement portion 253. Preferably, an arc center K of the first engagement groove 206 does not coincide with the axis center J of the lock pin 250. Specifically, as shown in FIG. 44, a line connecting an axis center N of the first pivot shaft 213 of the blade assembly 200 and the arc center K, and a line connecting the axis center N and the axis center J form an included angle therebetween. Therefore, when the second engagement portion 253 engages with the engagement groove, the second engagement portion 253 is in an eccentric state relative to the engagement groove. In this manner, the second engagement portion 253 applies an eccentric pressure to the engagement groove, forming a preload on the blade assembly 200, which can prevent the blade assembly 200 from wobbling after being opened or closed. An eccentric distance (i.e., a distance between the arc center K and the axis center J) varies depending on a material of the blade. For example, when a precision cast or stainless steel blade is used, the eccentric distance is 0.1-0.5 mm, preferably 0.2-0.25 mm; when a powder metallurgy blade is used, the eccentric distance is 0.1-0.8 mm, preferably 0.35-0.4 mm.

As shown in FIG. 45, in the folded state, the second engagement groove 207 of the blade assembly 200 engages with the second engagement portion 253 of the lock pin 250. The second engagement groove 207 is arcuate, where an arc length of the arcuate shape is greater than a semi-arc, thereby forming a constricted opening 209. That is, an opening width of the second engagement groove 207 is smaller than an arc diameter thereof, and the arc of the second engagement groove 207 is concentric with the axis center J of the lock pin 297, thereby effectively preventing the blade from disengaging and wobbling.

In some implementations, the blade assembly 200 is further provided with a third engagement groove 208, and the third engagement groove 208 is located between the first engagement groove 206 and the second engagement groove 207. When the third engagement groove 208 engages with the second engagement portion 253, the blade assembly 200 is between the unfolded position and the folded position. Compared with the opened state, the third engagement groove 208 cannot be provided with an interference amount. Therefore, an arc radius of the third engagement groove 208 is smaller than an arc radius of the first engagement groove 206. Preferably, the arc radius of the third engagement groove 208 is 0.2 mm smaller than the arc radius of the first engagement groove 206, and the arc of the third engagement groove 208 is concentric with the axis center J of the lock pin 250, thereby effectively preventing the blade assembly 200 from wobbling in the intermediate position.

The folding knife 20 in this embodiment can effectively improve engagement reliability between the lock pin 250 and the blade assembly 200, and reduce wobbling of the blade in the opened or closed state.

The above embodiments describe the technical solutions of the present invention. However, the scope of protection of the present invention is not limited to the above embodiments. It should be understood that those of ordinary skill in the art may make many modifications and variations based on the concept of the present invention without creative efforts. Therefore, any technical solution that can be obtained by those skilled in the art based on the concept of the present invention through logical analysis, reasoning, or limited experiments on the basis of the existing technology should also fall within the scope of protection defined by the claims.

1. A folding knife, comprising:
a handle;
a blade assembly pivotably connected to one end of the handle, the blade assembly being configured to be rotatable relative to the handle;
a locking mechanism configured to be engageable with the blade assembly;
wherein the folding knife is configured such that: the blade assembly has at least two states, the blade assembly is switched between different states by rotating, the locking mechanism, when engaged with the blade assembly, locks the blade assembly in a current state, and the locking mechanism, when disengaged from the blade assembly, is able to unlock the blade assembly.

2. The folding knife of claim 1, wherein the blade assembly has at least a folded state and an unfolded state; in the folded state, at least a portion of the blade assembly overlaps with the handle; in the unfolded state, the blade assembly extends outward from the handle.

3. The folding knife of claim 2, wherein the handle is provided with a receiving position capable of receiving the blade assembly, wherein:
the handle comprises a first shell and a second shell, and a cavity between the first shell and the second shell serves as the receiving position; or
the handle comprises a first shell and a second shell, the receiving position is provided on the first shell, and a portion of the second shell opposite to the receiving position is configured as an opening; or
the handle is formed by a single shell, and the receiving position is provided on the single shell.

4. The folding knife of claim 2, wherein the locking mechanism comprises a locking rod, and the locking rod is disposed on a side surface of the handle along a width direction and is pivotably connected to the handle; wherein an end portion of the locking rod extends toward the handle to form an extension section, a rear end of the blade assembly is provided with at least a first recess and a second recess, wherein when the extension section engages with the first recess, the blade assembly is locked in the unfolded state; and when the extension section engages with the second recess, the blade assembly is locked in the folded state.

5. The folding knife of claim 4, wherein when the extension section engages with the first recess, a first engagement surface of the extension section facing the space contacts the first recess to form a first contact surface; wherein a perpendicular line is drawn from an axis center of a pivot shaft of the locking rod to the engagement surface, and a foot of the perpendicular line is located within a height range of the first contact surface.

6. The folding knife of claim 5, wherein a second engagement surface of the extension section away from the space engages with an engagement surface of the first recess away from the space; wherein a portion of the second engagement surface near a bottom of the first recess is provided with a chamfer, and the chamfer has an inclined surface.

7. The folding knife of claim 5, wherein the handle is provided with a stop pin, and when the extension section engages with the first recess, the stop pin contacts an engagement surface of the first recess away from the space to restrict rotation of the blade assembly.

8. The folding knife of claim 5, wherein the extension section disengages from the first recess when rotating in a direction away from the first recess, wherein when the extension section rotates to a maximum stroke, a predetermined distance is provided between a lowermost end of the extension section near the first recess and an uppermost end of the first recess near the extension section.

9. The folding knife of claim 4, wherein the locking rod is partitioned, with a pivot shaft thereof as a boundary, into a first section and a second section, the locking mechanism further comprises a first resilient element, and the first resilient element applies a biasing force to the locking rod; the extension section is provided at an end portion of the first section, and pressing the second section drives the locking rod to rotate, wherein a distance from an end portion of the first section away from the pivot shaft to the pivot shaft is not less than a distance from a farthest pressable end of the second section to the pivot shaft.

10. The folding knife of claim 4, wherein when the extension section engages with the second recess, a torque generated by the extension section contacting the second recess causes the blade assembly to have a self-locking force in the second state.

11. The folding knife of claim 1, wherein the folding knife is provided with a blocking portion, and the blocking portion is configured to restrict the blade assembly from further moving when the blade assembly rotates toward the handle to a predetermined stroke.

12. The folding knife of claim 4, wherein the locking rod has a pivot hole, a pivot shaft passes through the pivot hole to pivotably connect the locking rod to the handle, wherein an axis center of the pivot shaft does not coincide with a hole center of the pivot hole, such that an outer side of the locking rod is not higher than the handle.

13. The folding knife of claim 3, wherein the locking mechanism comprises a lock pin and a second resilient element, and one end of the lock pin passes through a hole on the first shell and is movably connected to the second shell.

14. The folding knife of claim 13, wherein a rear end of the blade assembly is provided with at least a first engagement groove and a second engagement groove, and the lock pin is configured to be engageable with the first engagement groove or the second engagement groove, thereby locking the blade assembly in a current position.

15. The folding knife of claim 14, wherein the lock pin is a stepped shaft and comprises a first engagement portion, a second engagement portion, and a pressing end, wherein the pressing end protrudes outside the handle, and the first engagement portion is cylindrical and movably connected to the second shell; the second engagement portion is tapered and configured to be engageable with the first engagement groove or the second engagement groove.

16. The folding knife of claim 15, wherein the second shell is provided with a hole, at least a portion of the first engagement portion falls into the hole, and an engagement part between the first engagement portion and the hole has a predetermined height.

17. (canceled)

18. The folding knife of claim 15, wherein a side of the second engagement portion near the pressing end extends axially to form a cylindrical section.

19. The folding knife of claim 15, wherein the first engagement groove is arc-shaped, and when the first engagement groove engages with the second engagement portion, an arc center of the first engagement groove does not coincide with an axis center of the second engagement portion, and the second engagement portion applies a preload onto the first engagement groove; and
the second engagement groove is arcuate, and an arc length of the second engagement groove is greater than a semi-arc, thereby forming a constricted opening at an opening of the second engagement groove.

20. (canceled)

21. The folding knife of claim 14, wherein a rear end of the blade assembly is further provided with a third engagement groove, and the third engagement groove is located between the first engagement groove and the second engagement groove.

22. The folding knife of claim 13, wherein the second resilient element is a spring disposed between the lock pin and the handle; or
the second resilient element is a first resilient piece extending from the handle; or the folding knife comprises a clip connected to one side of the handle, and the second resilient element is a second resilient piece extending from the clip.

23-24. (canceled)
